(19) United States
(12) Patent Application Publication
(10) Pub. No.: US 2020/0111359 A1
(43) Pub. Date: Apr. 9, 2020

(54) APPARATUS FOR INFORMING DRIVING LANE AND CONTROL METHOD THEREOF

(71) Applicant: HYUNDAI MOBIS CO., LTD., Seoul (KR)

(72) Inventor: Hyungu YIM, Yongin-si (KR)

(21) Appl. No.: 16/592,534

(22) Filed: Oct. 3, 2019

(30) Foreign Application Priority Data
Oct. 8, 2018 (KR) 10-2018-0119735

(51) Int. Cl. G08G 1/0968; G08G 1/01; G01C 21/28; B60R 1/00; G01S 13/93

(52) U.S. Cl. CPC G08G 1/096855; G08G 1/01; G01C 21/28; B60R 1/00; G01S 13/931; B60R 2300/20; G01S 2013/9385; B60R 2300/804; B60R 2300/8066; B60R 2300/8086; B60R 2300/302; G01S 2013/9375; G01S 2013/9378; B60R 2300/301

(57) ABSTRACT

Provided are an apparatus for informing a driving lane and a control method thereof. The apparatus includes: a navigation information receiver configured to receive navigation information; a driver assistant system (DAS) sensor configured to detect front and surrounding states of own vehicle and provide a detection result; a controller configured to determine a driving lane of a highway from the navigation information, detect a lane change and a surrounding vehicle by using a rule-based technique and a naive Bayesian classification technique based on the front and surrounding states inputted from the DAS sensor, and correct the driving lane; and a display unit configured to display the driving lane determined or corrected by the controller.

### CROSS-REFERENCE TO RELATED APPLICATION

The present application claims priority under 35 U.S.C. § 119(a) to Korean Patent Application No. 10-2018-0119735, filed on Oct. 8, 2018 in the Korean Intellectual Property Office, which is incorporated herein by reference in its entirety.

### BACKGROUND

### 1. Technical Field

Embodiments of the present disclosure relate to an apparatus for informing a driving lane and a control method thereof, and more particularly, to an apparatus for informing a driving lane, which determines a driving lane of a vehicle driving on a highway by using a rule-based technique and a naive Bayesian classification technique based on a driver assistant system (DAS) sensor and navigation information during driving and continuously corrects and provides the driving lane, and a control method thereof.

### 2. Related Art

With the recent development of various sensors and recognition systems, an advanced driver assistant system (ADAS) mounted on vehicles has been actively commercialized.

A lane change informing system using such an advanced driver assistant system acquires information on blind spots on the rear and the side of a vehicle by using a plurality of sensors and informs a lane change safety state of a driver through a separate monitor, a warning sound or the like. That is, there has been developed and used an advanced safety vehicle (ASV) system that detects a position of a surrounding vehicle using a distance sensor or the like and informs a driver of information on the detected position of the surrounding vehicle.

Furthermore, a highway driving assistant system as the advanced driver assistant system allows a vehicle driving on a highway to maintain a lane, an inter-vehicle distance, and a setting speed through automatic steering control and automatic speed control, and additionally supports a lane change for a lane change order based on a lane change informing system.

The related art of the present disclosure is disclosed in Korean Patent Application Publication No. 2016-0117984 published on Oct. 11, 2016 and entitled “Lane change information system”.

When the highway driving assistant system or an autonomous vehicle supports a lane change according to a lane change order, since accurate information on a driving lane on which a vehicle is currently driving may increase reliability for the lane change, it is necessary to accurately determine and provide the driving lane of own vehicle.

### SUMMARY

Various embodiments are directed to an apparatus for informing a driving lane, which determines a driving lane of a vehicle driving on a highway by using a rule-based technique and a naive Bayesian classification technique based on a driver assistant system (DAS) sensor and navigation information during driving and continuously corrects and provides the driving lane, and a control method thereof.

In an embodiment, an apparatus for informing a driving lane includes: a navigation information receiver configured to receive navigation information; a driver assistant system (DAS) sensor configured to detect front and surrounding states of own vehicle and provide a detection result; a controller configured to determine a driving lane of a highway from the navigation information, detect a lane change and a surrounding vehicle by using a rule-based technique and a naive Bayesian classification technique based on the front and surrounding states inputted from the DAS sensor, and correct the driving lane; and a display unit configured to display the driving lane determined or corrected by the controller.

In an embodiment, the navigation information includes at least one information of a main road, a branch road, a merge road, the number of lanes, and a curvature of the highway.

In an embodiment, the DAS sensor includes at least one of a front camera, a front radar, a rear radar, and a side radar.

In an embodiment, the apparatus further includes an output unit configured to output the driving lane determined or corrected by the controller to a surrounding control device.

In an embodiment, the controller determines from the navigation information whether the own vehicle has entered a main road of the highway and determines the driving lane from the number of lanes that have been inputted.

In an embodiment, the controller determines the driving lane by probabilistically classifying a driving state of the surrounding vehicle based on a distance to the surrounding vehicle, a relative speed, a driving direction, and a detection time.

In an embodiment, the controller determines the driving lane by using the rule-based technique and corrects an error of the driving lane by using the naive Bayesian classification technique.

In an embodiment, the controller displays a surrounding preceding vehicle detected by the DAS sensor together with the driving lane.

In another embodiment, a control method of an apparatus for informing a driving lane includes: receiving, by a controller, navigation information from a navigation information receiver; determining, by the controller, a driving lane from the navigation information; receiving, by the controller, a detection result of front and surrounding states of own vehicle from a driver assistant system (DAS) sensor; correcting, by the controller, the driving lane when a lane change is detected based on the front and surrounding states of the own vehicle; correcting, by the controller, the driving lane by determining a driving state of a surrounding vehicle through a rule-based technique and a naive Bayesian classification technique based on the front and surrounding states of the own vehicle; and displaying, by the controller, the driving lane.

In an embodiment, the navigation information includes at least one information of a main road, a branch road, a merge road, the number of lanes, and a curvature of the highway.

In an embodiment, in the determining of the driving lane, the controller determines from the navigation information whether the own vehicle has entered a main road of the highway and determines the driving lane from the number of lanes that has been inputted.

In an embodiment, the method further includes receiving, by the controller, a front image from the DAS sensor after the own vehicle enters a main road, detecting a total number of lanes from the front image, comparing the detected total number of lanes and the number of lanes of the navigation information, and correcting the number of lanes.

In an embodiment, in the correcting of the driving lane by determining the driving state of the surrounding vehicle, the controller determines the driving lane by probabilistically classifying a driving state of the surrounding vehicle based on a distance to the surrounding vehicle, a relative speed, a driving direction, and a detection time.

In an embodiment, in the correcting of the driving lane by determining the driving state of the surrounding vehicle, the controller determines the driving lane by using the rule-based technique and corrects an error by using the naive Bayesian classification technique.

In an embodiment, the method further includes outputting, by the controller, the driving lane to a surrounding control device.

In an embodiment, the method further includes displaying, by the controller, a surrounding preceding vehicle detected by the DAS sensor together with the driving lane.

According to the apparatus for informing a driving lane and the control method thereof in accordance with an aspect of the present disclosure, the driving lane of a vehicle driving on a highway is determined using the rule-based technique and the naive Bayesian classification technique based on the DAS sensor and the navigation information during driving and is continuously corrected and provided, so that it is possible to improve reliability and safety when a highway driving support system or an autonomous vehicle supports a lane change according a lane change order.

### BRIEF DESCRIPTION OF THE DRAWINGS

FIG. 1 is a block diagram illustrating a configuration of an apparatus for informing a driving lane in accordance with an embodiment of the present disclosure.

FIG. 2 is a diagram illustrating an example in which an apparatus for informing a driving lane in accordance with an embodiment of the present disclosure forms feature parameters according to classes.

FIG. 3 is a flowchart for explaining a control method of an apparatus for informing a driving lane in accordance with an embodiment of the present disclosure.

### DETAILED DESCRIPTION

As is traditional in the corresponding field, some exemplary embodiments may be illustrated in the drawings in terms of functional blocks, units, and/or modules. Those of ordinary skill in the art will appreciate that these block, units, and/or modules are physically implemented by electronic (or optical) circuits such as logic circuits, discrete components, processors, hard-wired circuits, memory elements, wiring connections, and the like. When the blocks, units, and/or modules are implemented by processors or similar hardware, they may be programmed and controlled using software (e.g., code) to perform various functions discussed herein. Alternatively, each block, unit, and/or module may be implemented by dedicated hardware or as a combination of dedicated hardware to perform some functions and a processor (e.g., one or more programmed processors and associated circuitry) to perform other functions. Each block, unit, and/or module of some exemplary embodiments may be physically separated into two or more interacting and discrete blocks, units, and/or modules without departing from the scope of the inventive concept. Further, blocks, units, and/or module of some exemplary embodiments may be physically combined into more complex blocks, units, and/or modules without departing from the scope of the inventive concept.

Hereinafter, an apparatus for informing a driving lane and a control method thereof will be described below with reference to the accompanying drawings through various examples of embodiments. It should be noted that the drawings are not to precise scale and may be exaggerated in thickness of lines or sizes of components for descriptive convenience and clarity only. Furthermore, the terms as used herein are defined by taking functions of the disclosure into account and can be changed according to the custom or intention of users or operators. Therefore, definition of the terms should be made according to the overall disclosures set forth herein.

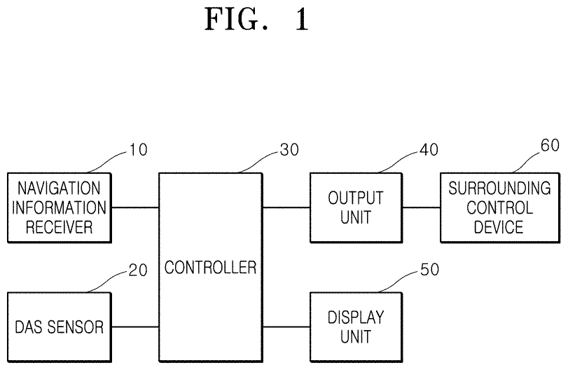

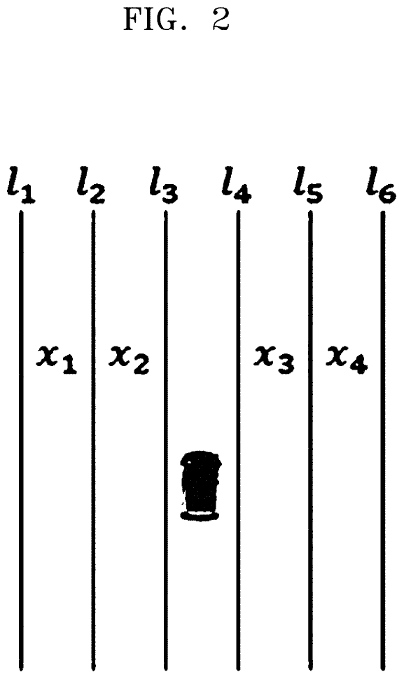

FIG. 1 is a block diagram illustrating a configuration of an apparatus for informing a driving lane in accordance with an embodiment of the present disclosure, and FIG. 2 is a diagram illustrating an example in which the apparatus for informing a driving lane in accordance with the embodiment of the present disclosure forms feature parameters according to classes.

As illustrated in FIG. 1, the apparatus for informing a driving lane in accordance with an embodiment of the present disclosure may include a navigation information receiver 10, a DAS sensor 20, a controller 30, a display unit 50, and an output unit 40.

The navigation information receiver 10 receives navigation information and provides the navigation information to the controller 30.

The navigation information may include a DAS map including at least one information of a main road, a branch road, a merge road, the number of lanes, and a curvature of a highway.

The DAS sensor 20 detects front and surrounding states of own vehicle and provides the detection result to the controller 30.

In such a case, the DAS sensor 20 may fuse sensor information to provide the quality, status, and age of a track for a detected object, thereby allowing the status of a dynamic object and a static object to be determined.

To this end, the DAS sensor 20 may be provided with a front camera and a front radar for monitoring the front of the own vehicle and may include a rear radar and a side radar for monitoring the rear and the side of the own vehicle.

The controller 30 determines a driving lane of a highway from the navigation information, and then corrects the driving lane according to a lane change and a surrounding vehicle by using a rule-based technique and a naive Bayesian classification technique based on the front and surrounding states inputted from the DAS sensor 20.

In such a case, the controller 30 may determine whether the own vehicle has entered the main road of the highway and the number of lanes from the navigation information by using the rule-based technique, and then determine the driving lane of the own vehicle.

That is, when the own vehicle has entered the main road, the controller 30 may determine the last one of the lanes of the highway as the driving lane.

Furthermore, when a barrier exists on the left side of the own vehicle, the controller 30 may determine the first lane as the driving lane by using road edge information. When the barrier exists on the right side of the own vehicle, the controller 30 may determine the last lane as the driving lane. In such a case, when the barrier is located at a distance shorter than ⅔ of the current lane width, the controller 30 may determine the last lane as the driving lane.

Meanwhile, when the own vehicle travels at a rest area, a sleeping shelter, or a shoulder, the controller 30 may also stop the determination and update of the driving lane.

Furthermore, the controller 30 may receive the number of lanes inputted from the navigation information and a front image from the DAS sensor 20 immediately after the own vehicle enters the main road of the highway, compare the number of lanes and the total number of lanes detected from the front image, and correct the number of lanes.

Then, when the lane change is detected based on the front and surrounding states of the own vehicle inputted from the DAS sensor 20, the controller 30 corrects the driving lane by adding or subtracting the number of driving lanes in the changed lane direction.

Meanwhile, the controller 30 may determine the driving lane by probabilistically classifying the driving state of the surrounding vehicle by using the naive Bayesian classification technique based on a distance to the surrounding vehicle, a relative speed, a driving direction, and a detection time, thereby correcting an error which may occur when determining the driving lane by using the rule-based technique.

For example, the controller 30 may determine the driving lane of the own vehicle through conditional probability based on a likelihood function for the dynamic objects in a region of interest by using object data outputted from the DAS sensor 20.

The region of interest may be set as a longitudinal distance of −50 m to 60 m based on the bumper of the own vehicle; however, the present disclosure is not limited thereto and the dynamic object may be determined as a case where the quality, the status, and the age of the track are equal to or more than a setting value.

Furthermore, when the static object is detected, the dynamic object located laterally outward from the static object is not used for updating the driving lane.

In such a case, the conditional probability based on the likelihood function is expressed by Equation 1 below.

$$H = arg max p ( C \vert Z ) = arg max \frac{p ( Z \vert C ) p ( C )}{p ( Z )} \qquad Equation 1$$

In Equation 1 above, p(C|Z) denotes a posterior probability, p(Z|C) denotes a likelihood function, p(C) denotes a prior probability, and p(Z) denotes an evidence.

Furthermore, C denotes a driving lane class, and when it is assumed that the own vehicle is driving in one of the first to eighth lanes (C={c₁, c₂, . . . , Cₛ}), Z denotes a transverse position of an object and is a measured value (Z={z₁, z₂, . . . , zₛ}) of 32 objects and xj denotes feature parameters (transverse positions of virtual lanes).

As illustrated in FIG. 2, in relation to the feature parameters that are factors that characterize the class, for example, when it is assumed that the own vehicle is located in one of the first to third lanes, there may be two lanes on the right side of the own vehicle if the own vehicle is located in the first lane, there may be one lane on the right side and one lane on the left side of the own vehicle if the own vehicle is located in the second lane, or there may be two lanes on the left side of the own vehicle if the own vehicle is located in the third lane. Accordingly, the total four feature parameters are required.

As described above, when the own vehicle is driving in the third lane, it is highly probable that a vehicle will travel in x1 and x2 and it is less probable that a vehicle will travel in x3 and x4.

In such a case, when it is assumed that the class C, the output Z of the object, and the feature parameter xj are probabilistically independent, the likelihood function may be defined by Equation 2 below.

p(C|Z)=Πᵢ₌₁³²p(Zᵢ|C)=Πᵢ₌₁³²p(Zᵢ|X)p(X|C)=Πᵢ₌₁³²Σⱼ₌₁⁴p(zᵢ|xⱼ)p(xⱼ|C) Equation 2

Accordingly, the current driving lane of the own vehicle may be determined based on a class having the highest posterior probability by applying Equation 2 above to Equation 1 above to calculate the probability that objects will be located in the feature parameters according to the classes.

For example, in a case where the fourth lane is determined as the driving lane in a four-lane road, when a vehicle driving on the right side of the own vehicle is detected as a result of determining the driving state of the surrounding vehicle inputted from the DAS sensor 20, the controller 30 corrects the driving lane from the fourth lane to the second lane or the third lane according to the driving state of the surrounding vehicle.

Furthermore, in a case where the first lane is determined as the driving lane, when a vehicle driving on the left side of the own vehicle is detected as a result of determining the driving state of the surrounding vehicle inputted from the DAS sensor 20, the controller 30 corrects the driving lane from the first lane to the second lane or the third lane according to the driving state of the surrounding vehicle.

The display unit 50 displays the driving lane determined or corrected by the controller 30, thereby allowing a driver to recognize the driving lane of the own vehicle.

In such a case, the controller 30 may display a surrounding preceding vehicle detected by the DAS sensor 20 together with the driving lane, thereby allowing a driver to recognize the driving state of the surrounding vehicle and to pay attention to a lane change.

Furthermore, the controller 30 may display a case where the surrounding vehicle is changing a lane or overtakes the own vehicle.

Meanwhile, the output unit 40 may output the driving lane determined or corrected by the controller 30 to a surrounding control device 60, thereby allowing the surrounding control device 60 to perform highly reliable control for the driving lane.

As described above, according to the apparatus for informing a driving lane in accordance with the embodiment of the present disclosure, the driving lane of a vehicle driving on a highway is determined using the rule-based technique and the naive Bayesian classification technique based on the DAS sensor and the navigation information during driving and is continuously corrected and provided, so that it is possible to improve reliability and safety when a highway driving support system or an autonomous vehicle supports a lane change according a lane change order.

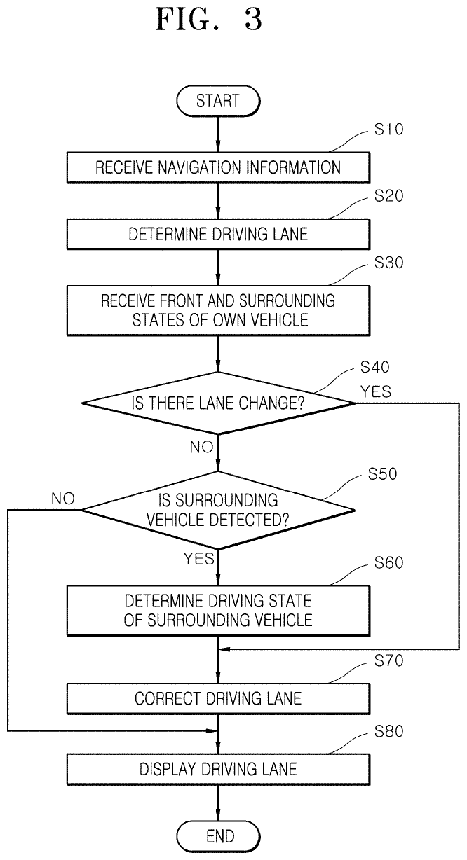

FIG. 3 is a flowchart for explaining a control method of the apparatus for informing a driving lane in accordance with an embodiment of the present disclosure.

As illustrated in FIG. 3, in the control method of the apparatus for informing a driving lane in accordance with the embodiment of the present disclosure, the controller 30 receives the navigation information from the navigation information receiver 10 (S10).

The navigation information may include the DAS map including at least one information of a main road, a branch road, a merge road, the number of lanes, and a curvature of a highway.

The controller 30 having received the navigation information in step S10 determines a driving lane from the navigation information (S20).

That is, the controller 30 may determine whether the own vehicle has entered the main road of the highway from the navigation information by using the rule-based technique, and then determine the last lane as the driving lane based on the number of lanes when the own vehicle has entered the main road of the highway.

Furthermore, when a barrier exists on the left side of the own vehicle, the controller 30 may determine the first lane as the driving lane by using road edge information. When the barrier exists on the right side of the own vehicle, the controller 30 may determine the last lane as the driving lane. In such a case, when the barrier is located at a distance shorter than ⅔ of the current lane width, the controller 30 may determine the last lane as the driving lane.

Meanwhile, when the own vehicle travels at a rest area, a sleeping shelter, or a shoulder, the controller 30 may also stop the determination and update of the driving lane.

Furthermore, the controller 30 may receive the number of lanes inputted from the navigation information and a front image from the DAS sensor 20 immediately after the own vehicle enters the main road of the highway, compare the number of lanes and the total number of lanes detected from the front image, and correct the number of lanes.

After determining the driving lane in step S20, the controller 30 receives the front and surrounding states of the own vehicle from the DAS sensor 20 (S30).

Then, the controller 30 determines whether to change a lane, based on the front and surrounding states of the own vehicle inputted from the DAS sensor 20 in step S30 (S40).

When the lane has been changed in step S40, the controller 30 corrects the driving lane by adding or subtracting the number of driving lanes in the changed lane direction (S70).

On the other hand, when no lane has been changed in step S40, the controller 30 detects a surrounding vehicle based on the front and surrounding states of the own vehicle inputted from the DAS sensor 20 (S50).

When no surrounding vehicle is detected in step S50, the controller 30 allows the display unit 50 to display the driving lane, thereby allowing a driver to recognize the driving lane (S80).

On the other hand, when the surrounding vehicle is detected in step S50, the controller 30 determines the driving lane by probabilistically classifying the driving state of the surrounding vehicle by using the naive Bayesian classification technique based on a distance to the surrounding vehicle, a relative speed, a driving direction, and a detection time (S60).

The feature parameters, which are factors that characterize the class, are formed as illustrated in FIG. 2 and the probability that objects will be located in the feature parameters according to the classes is calculated, so that it is possible to determine the current driving lane of the own vehicle based on a class having the highest posterior probability.

For example, when it is assumed that the own vehicle is necessarily located in one of the first to third lanes, there may be two lanes on the right side of the own vehicle if the own vehicle is located in the first lane, there may be one lane on the right side and one lane on the left side of the own vehicle if the own vehicle is located in the second lane, or there may be two lanes on the left side of the own vehicle if the own vehicle is located in the third lane.

Accordingly, when the own vehicle is driving in the third lane, it is highly probable that a vehicle will travel in x1 and x2 and it is less probable that a vehicle will travel in x3 and x4.

As described above, the probability that objects will be located in the feature parameters according to the classes is calculated, so that it is possible to determine the current driving lane of the own vehicle based on a class having the highest posterior probability.

As a result of determining the driving state of the surrounding vehicle in step S60, when there is a difference with the driving lane, the controller 30 corrects the driving lane (S70).

That is, it is possible to correct an error which may occur when determining the driving lane by using the rule-based technique.

For example, in a case where the fourth lane is determined as the driving lane in a four-lane road, when a vehicle driving on the right side of the own vehicle is detected as a result of determining the driving state of the surrounding vehicle inputted from the DAS sensor 20, the controller 30 corrects the driving lane from the fourth lane to the second lane or the third lane according to the driving state of the surrounding vehicle.

Furthermore, in a case where the first lane is determined as the driving lane, when a vehicle driving on the left side of the own vehicle is detected as a result of determining the driving state of the surrounding vehicle inputted from the DAS sensor 20, the controller 30 corrects the driving lane from the first lane to the second lane or the third lane according to the driving state of the surrounding vehicle.

The controller 30 allows the display unit 50 to output the driving lane determined in step S20 or corrected in step S70, thereby allowing a driver to recognize the driving lane of the own vehicle (S80).

In such a case, the controller 30 may display a surrounding preceding vehicle detected by the DAS sensor 20 together with the driving lane, thereby allowing a driver to recognize the driving state of the surrounding vehicle and to pay attention to a lane change.

Furthermore, the controller 30 may display a case where the surrounding vehicle is changing a lane or overtakes the own vehicle.

Meanwhile, the controller 30 outputs the determined or corrected driving lane to the surrounding control device 60 through the output unit 40, thereby allowing the surrounding control device 60 to perform highly reliable control for the driving lane.

As described above, according to the control method of the apparatus for informing a driving lane in accordance with the embodiment of the present disclosure, the driving lane of a vehicle driving on a highway is determined using the rule-based technique and the naive Bayesian classification technique based on the DAS sensor and the navigation information during driving and is continuously corrected and provided, so that it is possible to improve reliability and safety when a highway driving support system or an autonomous vehicle supports a lane change according a lane change order.

Although preferred embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. An apparatus for informing a driving lane, comprising:
a navigation information receiver configured to receive navigation information;
a driver assistant system (DAS) sensor configured to detect front and surrounding states of own vehicle and provide a detection result;
a controller configured to determine a driving lane of a highway from the navigation information, detect a lane change and a surrounding vehicle by using a rule-based technique and a naive Bayesian classification technique based on the front and surrounding states inputted from the DAS sensor, and correct the driving lane; and
a display unit configured to display the driving lane determined or corrected by the controller.

2. The apparatus of claim 1, wherein the navigation information includes at least one information of a main road, a branch road, a merge road, a number of lanes, and a curvature of the highway.

3. The apparatus of claim 1, wherein the DAS sensor includes at least one of a front camera, a front radar, a rear radar, and a side radar.

4. The apparatus of claim 1, further comprising:
an output unit configured to output the driving lane determined or corrected by the controller to a surrounding control device.

5. The apparatus of claim 1, wherein the controller determines from the navigation information whether the own vehicle has entered a main road of the highway and determines the driving lane from a number of lanes that have been inputted.

6. The apparatus of claim 1, wherein the controller determines the driving lane by probabilistically classifying a driving state of the surrounding vehicle based on a distance to the surrounding vehicle, a relative speed, a driving direction, and a detection time.

7. The apparatus of claim 1, wherein the controller determines the driving lane by using the rule-based technique and corrects an error of the driving lane by using the naive Bayesian classification technique.

8. The apparatus of claim 1, wherein the controller displays a surrounding preceding vehicle detected by the DAS sensor together with the driving lane.

9. A control method of an apparatus for informing a driving lane, comprising:
receiving, by a controller, navigation information from a navigation information receiver;
determining, by the controller, a driving lane from the navigation information;
receiving, by the controller, a detection result of front and surrounding states of own vehicle from a driver assistant system (DAS) sensor;
correcting, by the controller, the driving lane when a lane change is detected based on the front and surrounding states of the own vehicle;
correcting, by the controller, the driving lane by determining a driving state of a surrounding vehicle through a rule-based technique and a naive Bayesian classification technique based on the front and surrounding states of the own vehicle; and
displaying, by the controller, the driving lane.

10. The control method of claim 9, wherein the navigation information includes at least one information of a main road, a branch road, a merge road, a number of lanes, and a curvature of a highway.

11. The control method of claim 10, wherein in the determining of the driving lane, the controller determines from the navigation information whether the own vehicle has entered a main road of the highway and determines the driving lane from the number of lanes that has been inputted.

12. The control method of claim 11, further comprising:
receiving, by the controller, a front image from the DAS sensor after the own vehicle enters a main road, detecting a total number of lanes from the front image, comparing the detected total number of lanes and the number of lanes of the navigation information, and correcting the number of lanes.

13. The control method of claim 9, wherein in the correcting of the driving lane by determining the driving state of the surrounding vehicle, the controller determines the driving lane by probabilistically classifying a driving state of the surrounding vehicle based on a distance to the surrounding vehicle, a relative speed, a driving direction, and a detection time.

14. The control method of claim 9, wherein in the correcting of the driving lane by determining the driving state of the surrounding vehicle, the controller determines the driving lane by using the rule-based technique and corrects an error of the driving lane by using the naive Bayesian classification technique.

15. The control method of claim 9, further comprising:
outputting, by the controller, the driving lane to a surrounding control device.

16. The control method of claim 9, further comprising:
displaying, by the controller, a surrounding preceding vehicle detected by the DAS sensor together with the driving lane.
